(19) United States
(12) Patent Application Publication
(10) Pub. No.: US 2008/0018538 A1
(43) Pub. Date: Jan. 24, 2008

(54) Surface-Mount Antenna and Radio Communication Apparatus Including the Same

(75) Inventor: Yuichi Kushihi, Kanazawawa-shi (JP)

Correspondence Address: OSTROLENK FABER GERB & SOFFEN, 1180 AVENUE OF THE AMERICAS, NEW YORK, NY, 100368403, US

(73) Assignee: MURATA MANUFACTURING CO., LTD., Koyota-fu (JP)

(21) Appl. No.: 11/575,012

(22) PCT Filed: Sep. 9, 2005
(86) PCT No.: PCT/JP05/16620

§ 371 Date: Mar. 9, 2007

(30) Foreign Application Priority Data
Sep. 10, 2004 (JP) 2004-264174

(51) Int. Cl. H01Q 9/04

(52) U.S. Cl. 343/700 MS

(57) ABSTRACT

A surface-mount antenna, in which a radiation electrode to be connected to a radio-communication high-frequency circuit to operate as an antenna is formed on a base member 2. One end of the radiation electrode serves as a feeding portion for being connected to the radio-communication high-frequency circuit, and the other end of the radiation electrode is an open end. The radiation electrode includes a portion whose width is increased as it goes from the feeding portion toward the open end. The base member includes a band-like feeding electrode connected to the feeding portion of the radiation electrode to serve to connect the feeding portion to the high frequency circuit, and a ground electrode disposed on one side or both sides of the feeding electrode with a defined spacing between the feeding electrode and the ground electrode. The spacing between the ground electrode and the feeding electrode is set to be smaller than the width of the feeding electrode.

### CROSS-REFERENCE TO RELATED APPLICATIONS

This is a 35 U.S.C. §120 continuation of PCT/JP2005/016620 filed Sep. 9, 2005, which claims priority of JP2004-264174 filed Sep. 10, 2004, incorporated by reference.

### BACKGROUND OF THE INVENTION

1. Technical Field

The present invention relates to a surface-mount antenna with a configuration in which a radiation electrode is disposed on a base member, and also to a radio communication apparatus including the surface-mount antenna.

2. Background Art

As one type of monopole antenna, an antenna shown in FIG. 28 has been proposed (for example, see Non-Patent Document 1, below). An antenna 30 includes a disk-like ground plate 31 formed of a conductor and a radiation electrode 32 mounted on the ground plate 31. The radiation electrode 32 serves as a monopole antenna. The radiation electrode 32 is formed such that a conical portion 32a and a spherical portion 32b are connected to each other. The radiation electrode 32 is mounted over the ground plate 31 with a tip of the conical portion 32a facing the ground plate 31. The tip of the radiation electrode 32 is connected to a coaxial cable 33 disposed below the ground plate 31 via a through-hole formed in the ground plate 31. The coaxial cable 33 is connected to a radio-communication high-frequency circuit 34 provided for a radio communication apparatus, to allow the radiation electrode 32 to electrically connect to the radio-communication high-frequency circuit 34.

For example, when a transmission signal is supplied to the radiation electrode 32 from the high-frequency circuit 34 via the coaxial cable 33, the radiation electrode 32 is driven (operates as an antenna) to send the transmission signal by radio. When a signal is received by the radiation electrode 32 from an external source, the radiation electrode 32 is driven (operates as an antenna) to receive the signal, and the received signal is transmitted to the high-frequency circuit 34 via the coaxial cable 33 and is subjected to signal processing in the high-frequency circuit 34.

The above-described antenna 30 exhibits a horizontal-plane non-directional characteristic in a frequency band which is preset for radio communication. Also, the antenna 30 has an improved VSWR (voltage standing wave ratio) to be close to 1, which is the ideal state. In other words, the antenna 30 easily provides impedance matching between the radiation electrode 32 and the high-frequency circuit 34.

Non-Patent Document 1: Horizontal-plane Non-directional and Low-VSWR Antenna for UWB Wireless System by Takuya TANIGUCHI and Takehiko KOBAYASHI, 2002 IEICE Communications Society General Conference Theses, SB-1-5.

In accordance with the miniaturization of radio communication apparatuses, there is an increasing demand for decreasing the size of antennas. In the configuration of the antenna 30, however, the size of the radiation electrode 32 is determined mainly by the wavelength of the frequency band set for radio communication. Additionally, the radiation electrode 32 has a bulky structure, which is a combination of the conical portion 32a and the spherical portion 32b. It is thus difficult to miniaturize the antenna 30.

Further, the radiation electrode 32 has a pointed shape and a curve shape due to the combination of the conical portion 32a and the spherical portion 32b. It is thus difficult to mount the radiation electrode 32 configured as described above the ground plate 31, which is a flat plate. This makes the process of integrating the radiation electrode 32 into a radio communication apparatus troublesome, and the manufacturing cost becomes high.

### SUMMARY OF THE INVENTION

According to an embodiment of the present invention, the following configuration may be employed as means for solving the above problems. In a configuration of a surface-mount antenna, a radiation electrode formed on a base member may be connected to a radio-communication high-frequency circuit to operate as an antenna. One end of the radiation electrode serves as a feeding portion connected to the radio-communication high-frequency circuit, and the other end of the radiation electrode is an open end. The radiation electrode includes a portion whose width is increased as it goes from the feeding portion toward the open end. The base member includes a band-like feeding electrode connected to the feeding portion of the radiation electrode to serve to connect the feeding portion to the radio-communication high frequency circuit. A ground electrode disposed on one side or either side (both sides) of the feeding electrode with a spacing from the feeding electrode, and the spacing between the ground electrode and the feeding electrode is preferably smaller than the width of the feeding electrode.

A radio communication apparatus according to an embodiment of the present invention includes a circuit board including a ground area provided with a ground electrode and a non-ground area without a ground electrode. A surface-mount antenna having a configuration embodying the present invention is disposed on the non-ground area of the circuit board, and the circuit board includes a connector for connecting the ground electrode of the surface-mount antenna to the ground electrode of the circuit board.

According to the above-mentioned embodiment of the present invention, the radiation electrode includes a portion whose width is increased as it goes from the feeding portion toward the open end. This radiation electrode can serve as a monopole antenna. The radiation electrode can exhibit a horizontal-plane non-directional characteristic depending on the shape of the radiation electrode, moreover easily achieving a wider frequency band and improved VSWR. In this embodiment of the present invention, the radiation electrode is entirely formed on a surface of the base member formed of a dielectric member or a magnetic member. Accordingly, since the whole area of the radiation electrode is influenced by the base member, there is a wavelength shortening effect in accordance with the dielectric constant of the base member. Thus, it is easy to reduce the size of the radiation electrode (i.e., to miniaturize the surface-mount antenna).

The radiation electrode is formed on the surface of the base member. Accordingly, by simply disposing the base member provided with the radiation electrode on, for example, the circuit board of the radio communication apparatus, the surface-mount antenna can be integrated into the radio communication apparatus easily and quickly. For example, by fixing the base member of the surface-mount antenna on the circuit board of the radio communication apparatus by soldering, the surface-mount antenna can be fixed (surface-mounted) on the circuit board of the communication apparatus simultaneously with the surface-mounting step of fixing electronic components on the circuit board by soldering. This eliminates the need to provide a step of integrating the surface-mount antenna into the circuit board separately from the step of mounting electronic components on the circuit board. Thus, the manufacturing process for the radio communication apparatus can be simplified.

With the embodiments of the present invention, it becomes easy to increase the frequency bandwidth, to improve VSWR, and to reduce the size of the surface-mount antenna. The operation for integrating the surface-mount antenna into the radio communication apparatus can also be facilitated.

Moreover, in the embodiments of the present invention, the base member of the surface-mount antenna may include the band-like feeding electrode for connecting the radiation electrode to the radio-communication high frequency circuit. The ground electrode may be disposed on one side or on either side (both sides) of the feeding electrode with a spacing from the feeding electrode. By locating the ground electrode closely to the feeding electrode on the base member, a capacitance can be formed between the feeding portion of the radiation electrode and the ground to such a degree as to influence the resonant frequencies of the radiation electrode. Accordingly, for example, if the capacitance between the feeding portion of the radiation electrode and the ground electrode is set to be variable, the resonant frequency of each of a plurality of resonant modes can be changed.

Additionally, as the frequency increases, the capacitance between the feeding portion of the radiation electrode and the ground produces a greater influence on the resonance operation (for example, the resonant frequency) of the radiation electrode. Thus, if the capacitance between the feeding portion of the radiation electrode and the ground is set to be variable, the resonant frequency of the higher modes, which are higher than the resonant frequency of the fundamental mode, can be changed more sharply than the resonant frequency of the fundamental mode, which is the lowest frequency among a plurality of resonant modes of the radiation electrode. In other words, by varying the capacitance between the feeding portion of the radiation electrode and the ground generated by the feeding electrode and the ground electrode, the resonant frequency of the higher modes can be changed sharply while suppressing a change in the resonant frequency of the fundamental mode of the radiation electrode.

In the present invention, the spacing between the ground electrode and the feeding electrode is preferably smaller than the width of the feeding electrode. With this configuration, the capacitance between the feeding portion of the radiation electrode and the ground becomes larger, as compared with the case where the spacing between the ground electrode and the feeding electrode is larger than the width of the feeding electrode. Because of this large capacitance between the feeding portion of the radiation electrode and the ground, the resonant frequency of the higher modes of the radiation electrode can be changed to get closer to the resonant frequency of the fundamental mode while suppressing the change of the resonant frequency of the fundamental mode of the radiation electrode. Thus, the frequency band of the higher modes can be partially overlapped with the frequency band of the fundamental mode. That is, the coupling frequency band between the frequency band of the fundamental mode and the frequency band of the higher modes can be formed so that the frequency bandwidth can be increased.

Since the surface-mount antenna embodying the present invention is small, the radio communication apparatus including such a small surface-mount antenna can also be miniaturized. The surface-mount antenna of the present invention exhibits a wide frequency band, and thus, even if only one such surface-mount antenna is provided, the surface-mount antenna can be used with a radio communication apparatus with a wide frequency band.

Other features and advantages of the present invention will become apparent from the following description of embodiments of invention which refers to the accompanying drawings.

### BRIEF DESCRIPTION OF THE DRAWINGS

FIG. 1 is a perspective view schematically illustrating a surface-mount antenna of a first embodiment.

FIG. 2 is an isometric view illustrating the surface-mount antenna shown in FIG. 1.

FIG. 3a is a perspective view illustrating an example of surface-mounting the surface-mount antenna shown in FIG. 1 on a circuit board.

FIG. 3b is an exploded view illustrating an example of the configuration of the circuit board shown in FIG. 3a.

FIG. 4 is a perspective view schematically illustrating a comparative example in relation to the surface-mount antenna of the first embodiment.

FIG. 5a illustrates the conditions for the experiment conducted by the present inventor.

FIG. 5b is a graph illustrating the experiment result of sample A (having the configuration of the surface-mount antenna of the first embodiment) obtained by the experiment conducted by the present inventor.

FIG. 5c is a graph illustrating the experiment result of sample B (having the configuration of the surface-mount antenna of the comparative example) obtained by the experiment conducted by the present inventor.

FIG. 6 is a perspective view schematically illustrating a surface-mount antenna of a second embodiment.

FIG. 7 is a perspective view schematically illustrating a comparative example in relation to the surface-mount antenna of the second embodiment.

FIG. 8a illustrates the conditions for the experiment conducted by the present inventor.

FIG. 8b is a graph illustrating the experiment result of sample A′ (having the configuration of the surface-mount antenna of the second embodiment) obtained by the experiment conducted by the present inventor.

FIG. 8c is a graph illustrating the experiment result of sample B′ (having the configuration of the surface-mount antenna of the comparative example) obtained by the experiment conducted by the present inventor.

FIG. 9a is a graph illustrating a reflection characteristic of the surface-mount antenna simulated under the condition that the width H of the feeding electrode is 0.4 mm and the spacing d1 and spacing d2 between the feeding electrode and the ground electrodes are 0.3 mm.

FIG. 9b is a graph illustrating a reflection characteristic of the surface-mount antenna simulated under the condition that the width H of the feeding electrode is 0.4 mm and the spacing d1 and spacing d2 between the feeding electrode and the ground electrodes are 0.36 mm.

FIG. 10a is a graph illustrating a reflection characteristic of the surface-mount antenna simulated under the condition that the width H of the feeding electrode is 0.5 mm and the spacing d1 and spacing d2 between the feeding electrode and the ground electrodes are 0.3 mm.

FIG. 10b is a graph illustrating a reflection characteristic of the surface-mount antenna simulated under the condition that the width H of the feeding electrode is 0.5 mm and the spacing d1 and spacing d2 between the feeding electrode and the ground electrodes are 0.45 mm.

FIG. 11a is a graph illustrating a reflection characteristic of the surface-mount antenna simulated under the condition that the width H of the feeding electrode is 0.6 mm and the spacing d1 and spacing d2 between the feeding electrode and the ground electrodes are 0.3 mm.

FIG. 11b is a graph illustrating a reflection characteristic of the surface-mount antenna simulated under the condition that the width H of the feeding electrode is 0.6 mm and the spacing d1 and spacing d2 between the feeding electrode and the ground electrodes are 0.54 mm.

FIG. 12a is a graph illustrating a reflection characteristic of the surface-mount antenna simulated under the condition that the width H of the feeding electrode is 0.7 mm and the spacing d1 and spacing d2 between the feeding electrode and the ground electrodes are 0.3 mm.

FIG. 12b is a graph illustrating a reflection characteristic of the surface-mount antenna simulated under the condition that the width H of the feeding electrode is 0.7 mm and the spacing d1 and spacing d2 between the feeding electrode and the ground electrodes are 0.63 mm.

FIG. 13a is a graph illustrating a reflection characteristic of the surface-mount antenna simulated under the condition that the width H of the feeding electrode is 0.8 mm and the spacing d1 and spacing d2 between the feeding electrode and the ground electrodes are 0.3 mm.

FIG. 13b is a graph illustrating a reflection characteristic of the surface-mount antenna simulated under the condition that the width H of the feeding electrode is 0.8 mm and the spacing d1 and spacing d2 between the feeding electrode and the ground electrodes are 0.72 mm.

FIG. 14a is a graph illustrating a reflection characteristic of the surface-mount antenna simulated under the condition that the width H of the feeding electrode is 0.9 mm and the spacing d1 and spacing d2 between the feeding electrode and the ground electrodes are 0.3 mm.

FIG. 14b is a graph illustrating a reflection characteristic of the surface-mount antenna simulated under the condition that the width H of the feeding electrode is 0.9 mm and the spacing d1 and spacing d2 between the feeding electrode and the ground electrodes are 0.81 mm.

FIG. 15a is a graph illustrating a reflection characteristic of the surface-mount antenna simulated under the condition that the width H of the feeding electrode is 1.0 mm and the spacing d1 and spacing d2 between the feeding electrode and the ground electrodes are 0.3 mm.

FIG. 15b is a graph illustrating a reflection characteristic of the surface-mount antenna simulated under the condition that the width H of the feeding electrode is 1.0 mm and the spacing d1 and spacing d2 between the feeding electrode and the ground electrodes are 0.90 mm.

FIG. 16a is a graph illustrating a reflection characteristic of the surface-mount antenna simulated under the condition that the width H of the feeding electrode is 1.1 mm and the spacing d1 and spacing d2 between the feeding electrode and the ground electrodes are 0.3 mm.

FIG. 16b is a graph illustrating a reflection characteristic of the surface-mount antenna simulated under the condition that the width H of the feeding electrode is 1.1 mm and the spacing d1 and spacing d2 between the feeding electrode and the ground electrodes are 0.99 mm.

FIG. 17a is a graph illustrating a reflection characteristic of the surface-mount antenna simulated under the condition that the width H of the feeding electrode is 1.2 mm and the spacing d1 and spacing d2 between the feeding electrode and the ground electrodes are 0.3 mm.

FIG. 17b is a graph illustrating a reflection characteristic of the surface-mount antenna simulated under the condition that the width H of the feeding electrode is 1.2 mm and the spacing d1 and spacing d2 between the feeding electrode and the ground electrodes are 1.08 mm.

FIG. 18a is a graph illustrating a reflection characteristic of the surface-mount antenna simulated under the condition that the width H of the feeding electrode is 1.3 mm and the spacing d1 and spacing d2 between the feeding electrode and the ground electrodes are 0.3 mm.

FIG. 18b is a graph illustrating a reflection characteristic of the surface-mount antenna simulated under the condition that the width H of the feeding electrode is 1.3 mm and the spacing d1 and spacing d2 between the feeding electrode and the ground electrodes are 1.17 mm.

FIG. 19a is a graph illustrating a reflection characteristic of the surface-mount antenna simulated under the condition that the width H of the feeding electrode is 1.4 mm and the spacing d1 and spacing d2 between the feeding electrode and the ground electrodes are 0.3 mm.

FIG. 19b is a graph illustrating a reflection characteristic of the surface-mount antenna simulated under the condition that the width H of the feeding electrode is 1.4 mm and the spacing d1 and spacing d2 between the feeding electrode and the ground electrodes are 1.26 mm.

FIG. 20a is a graph illustrating a reflection characteristic of the surface-mount antenna simulated under the condition that the width H of the feeding electrode is 1.5 mm and the spacing d1 and spacing d2 between the feeding electrode and the ground electrodes are 0.3 mm.

FIG. 20b is a graph illustrating a reflection characteristic of the surface-mount antenna simulated under the condition that the width H of the feeding electrode is 1.5 mm and the spacing d1 and spacing d2 between the feeding electrode and the ground electrodes are 1.35 mm.

FIG. 21a is a graph illustrating a reflection characteristic of the surface-mount antenna simulated under the condition that the width H of the feeding electrode is 1.6 mm and the spacing d1 and spacing d2 between the feeding electrode and the ground electrodes are 0.3 mm.

FIG. 21b is a graph illustrating a reflection characteristic of the surface-mount antenna simulated under the condition that the width H of the feeding electrode is 1.6 mm and the spacing d1 and spacing d2 between the feeding electrode and the ground electrodes are 1.44 mm.

FIG. 22a is a graph illustrating a reflection characteristic of the surface-mount antenna simulated under the condition that the width H of the feeding electrode is 1.7 mm and the spacing d1 and spacing d2 between the feeding electrode and the ground electrodes are 0.3 mm.

FIG. 22b is a graph illustrating a reflection characteristic of the surface-mount antenna simulated under the condition that the width H of the feeding electrode is 1.7 mm and the spacing d1 and spacing d2 between the feeding electrode and the ground electrodes are 1.53 mm.

FIG. 23a is a graph illustrating a reflection characteristic of the surface-mount antenna simulated under the condition that the width H of the feeding electrode is 1.8 mm and the spacing d1 and spacing d2 between the feeding electrode and the ground electrodes are 0.3 mm.

FIG. 23b is a graph illustrating a reflection characteristic of the surface-mount antenna simulated under the condition that the width H of the feeding electrode is 1.9 mm and the spacing d1 and spacing d2 between the feeding electrode and the ground electrodes are 0.3 mm.

FIG. 23c is a graph illustrating a reflection characteristic of the surface-mount antenna simulated under the condition that the width H of the feeding electrode is 2.0 mm and the spacing d1 and spacing d2 between the feeding electrode and the ground electrodes are 0.3 mm.

FIG. 24 is a graph illustrating a reflection characteristic of the surface-mount antenna simulated under the condition that the width H of the feeding electrode is 0.3 mm and the spacing d1 and spacing d2 between the feeding electrode and the ground electrodes are 0.27 mm.

FIG. 25 is a graph illustrating an example of the relationship between the width H of the feeding electrode and the lowest value of the reflection characteristic around a frequency of 5 GHz obtained from the simulation results indicated in FIGS. 9a through 24.

FIG. 26 illustrates another embodiment.

FIG. 27a illustrates another configuration of the radiation electrode.

FIG. 27b illustrates still another configuration of the radiation electrode.

FIG. 27c illustrates yet another configuration of the radiation electrode.

FIG. 27d illustrates another additional configuration of the radiation electrode.

FIG. 28 is a schematic perspective view illustrating an example of a known antenna.

### DETAILED DESCRIPTION OF EMBODIMENTS OF THE INVENTION

### Reference Numerals

1 surface-mount antenna
2 dielectric base member
3 radiation electrode
4 feeding electrode
5 ground electrode
7 radio-communication high-frequency circuit
10 circuit board
11 ground electrode

Embodiments of the present invention are described below with reference to the drawings.

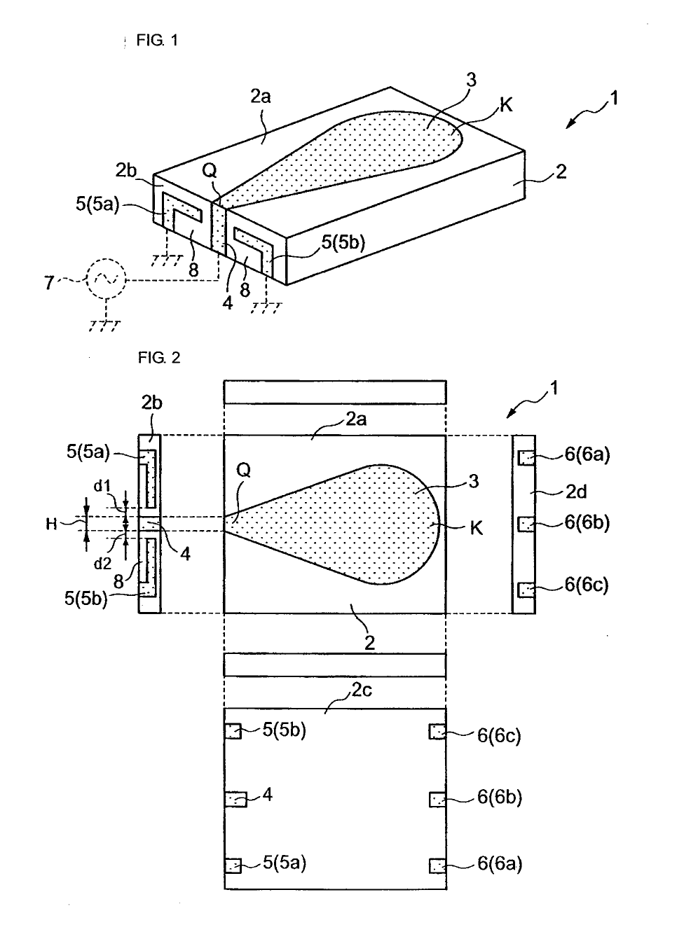

A surface-mount antenna of a first embodiment is schematically shown in the perspective view of FIG. 1. FIG. 2 is an isometric view schematically illustrating the surface-mount antenna shown in FIG. 1. The surface-mount antenna 1 of the first embodiment includes a rectangular-parallelepiped base member (dielectric base member) 2, a radiation electrode 3 formed on a top major surface 2a of the dielectric base member 2, a feeding electrode 4, and ground electrodes 5 (5a, 5b), the feeding electrode 4 and the ground electrodes 5 being formed on a lateral surface 2b of the dielectric base member 2.

One end of the radiation electrode 3 serves as a feeding portion Q, and the other end of the radiation electrode 3 is an open end K. The radiation electrode 3 is formed in a teardrop shape in which the width is increased as it goes from the feeding portion Q toward the open end K. The radiation electrode 3 can be operated as a monopole antenna. The radiation electrode 3, for example, the size thereof, is designed so that it can perform radio signal communication in a preset frequency band. Since the radiation electrode 3 is formed in a teardrop shape, it is easy to obtain the horizontal-plane non-directional characteristic and also to increase the frequency band and improve VSWR.

The feeding electrode 4 has a band-like or strip-like shape. It is rectangular in this example. One end of the feeding electrode 4 is connected to the feeding portion Q of the radiation electrode 3 (i.e., the tip of the teardrop-shaped radiation electrode 3). The other end of the feeding electrode 4 is formed on the lateral surface 2b and further turns over onto a bottom surface 2c of the dielectric base member 2. The feeding electrode 4 is used for connecting the feeding portion Q of the radiation electrode 3 to a radio-communication high-frequency circuit 7 provided for a radio communication apparatus.

The ground electrodes 5 (5a, 5b) are disposed on the lateral surface 2b, on opposite sides of the feeding electrode 4 with a spacing therebetween. The ground electrodes 5 (5a, 5b) are grounded. The ground electrodes 5 (5a, 5b) are extended from the lateral surface 2b to the edge of the bottom surface 2c of the dielectric base member 2. In the first embodiment, the spacing d1 between the ground electrode 5a and the feeding electrode 4 and the spacing d2 between the ground electrode 5b and the feeding electrode 4 are smaller than the width H of the feeding electrode 4.

In the first embodiment, the ground electrodes 5 (5a, 5b) are provided with notches 8 defined at positions near the feeding electrode 4, extending from the bottom edge of the lateral surface 2b adjacent to the bottom surface 2c of the dielectric base member, to a level defined below the top edge of the lateral surface 2b and below the ground electrodes 5a, 5b.

When surface-mounting the surface-mount antenna 1 of the first embodiment on the circuit board of the radio communication apparatus by soldering, which is described below, solder is attached to the feeding electrode 4 and to the ground electrodes 5 formed on the bottom surface. If the bottom portion of the feeding electrode 4 and the bottom portions of the ground electrodes 5 were disposed adjacent to each other with a spacing smaller than the width H of the feeding electrode 4, the solder attached to the bottom portion of the feeding electrode 4 and the solder attached to the bottom portions of the ground electrodes 5 could form a solder bridge, which could cause short-circuiting. In contrast, as in the first embodiment, by forming the notches 8 below the ground electrodes 5, the spacing between the bottom portions of the ground electrodes 5 and the bottom portion of the feeding electrode 4 may be increased. This can avoid the formation of a solder bridge between the feeding electrode 4 and the ground electrodes 5, and as a result, short-circuiting can be prevented.

In the first embodiment, fixing electrodes 6 (6a, 6b, 6c) are formed on a lateral surface 2d of the dielectric base member 2. The fixing electrodes 6 (6a, 6b, 6c) are electrodes specifically used as base electrodes for soldering when fixing (surface-mounting) the surface-mount antenna 1 on the circuit board of the radio communication apparatus by soldering.

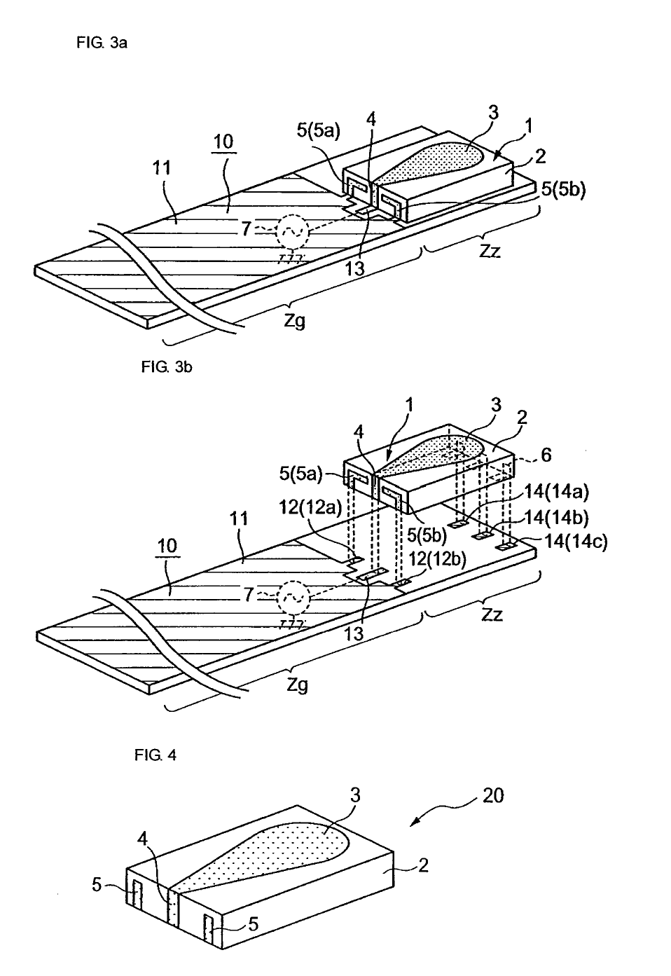

The surface-mount antenna 1 of the first embodiment is configured as described above. The surface-mount antenna 1 is surface-mounted on a circuit board 10 of the radio communication apparatus, as shown in, for example, the model diagram of FIG. 3a, so that it can be integrated into the radio communication apparatus. The circuit board 10 includes a ground area Zg on which a ground electrode 11 having a ground potential is formed and a non-ground area Zz on which the ground electrode 11 is not formed. The surface-mount antenna 1 is disposed on the non-ground area Zz. In the non-ground area Zz of the circuit board 10, the ground electrode 11 is not formed on the rear surface or the inner layer of the circuit board 10.

In the non-ground area Zz of the circuit board 10, as shown in FIG. 3b, grounding wiring patterns 12 (12a, 12b) continuously connected to the ground electrode 11, a feeding wiring pattern 13 electrically connected to the radio-communication high-frequency circuit 7, and fixing conductor patterns 14 (14a, 14b, 14c), which are electrically isolated, are formed. In the step of disposing the surface-mount antenna 1 on the non-ground area Zz of the circuit board 10, the ground electrodes (5a, 5b) of the surface-mount antenna 1 are positioned to the grounding wiring patterns 12 (12a, 12b) of the circuit board 10. The feeding electrode 4 of the surface-mount antenna 1 is positioned to the feeding wiring pattern 13 of the circuit board 10. The fixing electrodes 6 (6a, 6b, 6c) of the surface-mount antenna 1 are positioned to the fixing conductor patterns 14 (14a, 14b, 14c) of the circuit board 10. With the elements of the surface-mount antenna 1 thus positioned to the corresponding elements of the circuit board 10, the surface-mount antenna 1 is mounted on the surface of the non-ground area Zz of the circuit board 10.

Then, a conductive bonding material, such as a solder, is used for bonding the ground electrodes 5 (5a, 5b) of the surface-mount antenna 1 and the grounding wiring patterns 12 (12a, 12b) of the circuit board 10, the feeding electrode 4 of the surface-mount antenna 1 and the feeding wiring pattern 13 of the circuit board 10, and the fixing electrodes 6 (6a, 6b, 6c) of the surface-mount antenna 1 and the fixing conductor patterns 14 (14a, 14b, and 14c) of the circuit board 10. Accordingly, the surface-mount antenna 1 is fixed on the circuit board 10, and the ground electrodes 5 (5a, 5b) of the surface-mount antenna 1 are grounded to the ground electrode 11 via the grounding wiring patterns 12 (12a, 12b). The feeding electrode 4 of the surface-mount antenna 1 is connected to the radio-communication high-frequency circuit 7 through the feeding wiring pattern 13 of the circuit board 10.

After the surface-mount antenna 1 is surface-mounted on the circuit board 10, for example, a transmission signal is sent to the feeding electrode 4 of the surface-mount antenna 1 from the radio-communication high-frequency circuit 7 via the feeding wiring pattern 13. Then, the transmission signal is supplied to the radiation electrode 3, so that the radiation electrode 3 is driven to transmit the transmission signal by radio. When a signal is transmitted by an external source, the radiation electrode 3 is driven to receive the signal, and the received signal is then sent to the radio-communication high-frequency circuit 7 via the feeding electrode 4 and the feeding wiring pattern 13 and is subjected to signal processing by the radio-communication high-frequency circuit 7.

As stated above, in the surface-mount antenna 1 of the first embodiment, the spacing d1 and the spacing d2 between the feeding electrode 4 and the ground electrodes 5 (5a, 5b), respectively, are smaller than the width H of the feeding electrode 4. With this configuration, the frequency band can be increased and VSWR can be improved compared with when the spacing d1 and the spacing d2 are greater than the width H of the feeding electrode 4. This has been proved by experiment by the present inventor.

In that experiment, reflection characteristics of the following samples A and B were simulated. Sample A is the surface-mount antenna 1, such as that shown in FIG. 1, having a configuration unique to the first embodiment (i.e., the configuration in which the spacing between the feeding electrode 4 and each ground electrode 5 is smaller than the width of the feeding electrode 4). Sample B is a comparative example in contrast to sample A. Sample B is a surface-mount antenna 20 having a configuration in which the spacing between the feeding electrode 4 and each ground electrode 5 is greater than the width of the feeding electrode 4, as shown in FIG. 4. The configuration of sample A and that of sample B are similar to each other, except for the spacing between the feeding electrode 4 and each ground electrode 5.

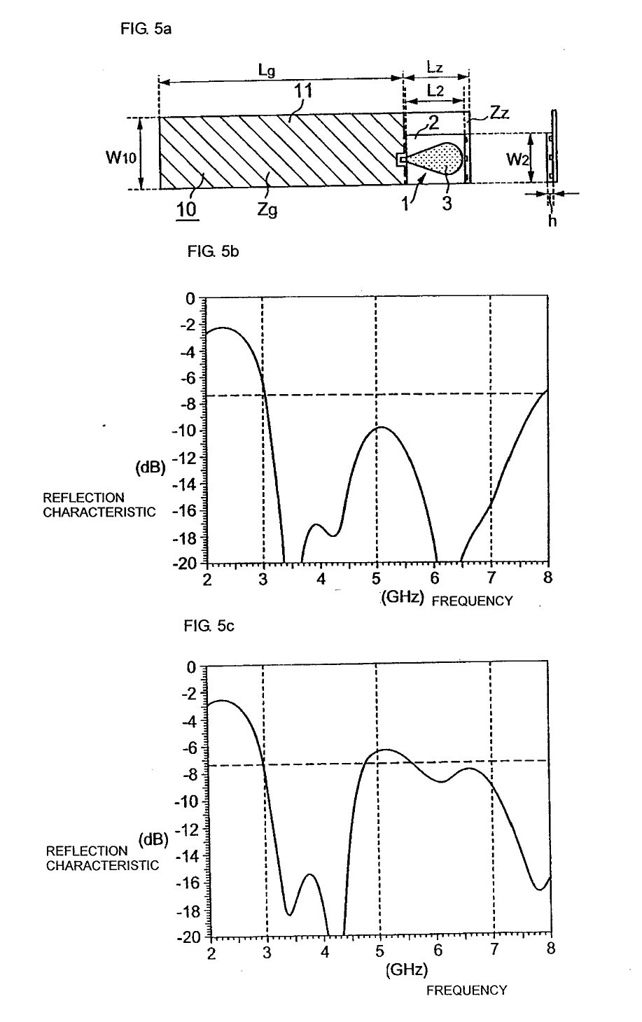

The reflection characteristics of sample A and sample B were simulated, under the same condition that sample A and sample B were surface-mounted on the non-ground area Zz of the circuit board 10, as shown in the plan view of FIG. 5a. In this experiment, the circuit board 10 and the dielectric base members 2 of the surface-mount antennas 1 and 20 have the following dimensions. The width W₁₀ of the circuit board 10 is 18 mm; the length Lg of the ground area Zg of the circuit board 10 is 63.5 mm; and the length Lz of the non-ground area Zz of the circuit board 10 is 16.5 mm. The width W₂ of the dielectric base member 2 of the surface-mount antenna 1 is 12 mm; the length L₂ of the dielectric base member 2 is 15 mm; and the height h of the dielectric base member 2 is 1.5 mm.

The simulated reflection characteristic of sample A (i.e., the surface-mount antenna 1 of the first embodiment) is shown in FIG. 5b, while the simulated reflection characteristic of sample B (i.e., the surface-mount antenna 20 of the comparative example) is shown in FIG. 5c. The bands implementing a reflection characteristic of −7.4 dB or lower (i.e., the band implementing VSWR of 2.5 or smaller, which is the standard for determining whether radio communication can be performed under good conditions) in sample A and sample B are as follows. In sample B (comparative example), as shown in FIG. 5c, the band implementing a reflection characteristic of −7.4 dB or lower corresponds to two bands, i.e., the band from about 3.0 GHz to about 4.7 GHz and the band from about 5.7 GHz to 8 GHz or higher. In contrast, in sample A (first embodiment), the band implementing a reflection characteristic of −7.4 dB or lower corresponds to one continuous band from about 3.1 GHz to about 7.9 GHz. That is, the reflection characteristics shown in FIGS. 5b and 5c have proved that, according to the preferred characteristic of the first embodiment (i.e., the characteristic in which the spacing between the feeding electrode 4 and each ground electrode 5 is smaller than the width of the feeding electrode 4), the frequency band can be increased.

The present inventor believes that the reason for achieving an increase in the frequency band by this configuration is as follows. The spacing between the feeding electrode 4 and each ground electrode 5 of sample A (surface-mount antenna 1 of the first embodiment) is smaller than the width of the feeding electrode 4. Accordingly, the capacitance between the feeding portion side of the radiation electrode 3 and the ground is greater than that of sample B (comparative example). Additionally, the resonant frequency of the fundamental mode of sample A is about 3.5 GHz, as shown in FIG. 5b, while the resonant frequency of the fundamental mode of sample B is about 4.2 GHz, as shown in FIG. 5c. Accordingly, the difference in the spacing between the feeding electrode 4 and the ground electrodes 5 between sample A and sample B, does not cause any large disparity in the resonant frequency of the fundamental mode between sample A and sample B. In contrast, the resonant frequency of a higher mode of sample A is about 6.2 GHz, while the resonant frequency of a higher mode of sample B is about 7.9 GHz. Accordingly, in sample A, the resonant frequency of the higher mode gets closer to the resonant frequency of the fundamental mode as compared with the case of sample B, and thus, there is a large disparity in the resonant frequency of the higher mode between sample A and sample B.

The experiment result has proved that, as the capacitance between the feeding portion side of the radiation electrode 3 and the ground generated by the feeding electrode 4 and the ground electrode 5 is increased, the resonant frequency of the higher mode gets closer to the resonant frequency of the fundamental mode while suppressing change of the resonant frequency of the fundamental mode. As in the configuration of the first embodiment (as in sample A), by setting the spacing between the feeding electrode 4 and each ground electrode 5 to be smaller than the width of the feeding electrode 4, the capacitance between the feeding portion side of the radiation electrode 3 and the ground is increased, and as a result, the resonant frequency of the higher mode gets closer to that of the fundamental mode to such a degree that the resonant frequency band of the higher mode can be partially overlapped with the resonant frequency band of the fundamental mode. Since the resonant frequency band of the higher mode is partially overlapped with that of the fundamental mode, the reflection characteristic (VSWR) in the frequency range between the resonant frequency of the fundamental mode and the resonant frequency of the higher mode is considerably improved, thereby achieving a wider bandwidth.

Because of the above-described reason, by adjusting the spacing d1 or spacing d2 between the feeding electrode 4 and the ground electrode 5, the frequency bandwidth can be changed. In the first embodiment, therefore, the spacing d1 and the spacing d2 between the feeding electrode 4 and the ground electrodes (5a, 5b) are smaller than the width of the feeding electrode 4. More particularly, the spacing d1 or d2 can be designed so that the surface-mount antenna 1 can satisfy the bandwidth demanded by the specifications.

A second embodiment is described below. In the description of the second embodiment, the same elements as those of the first embodiment are designated with like reference numerals, and an explanation thereof is thus omitted here.

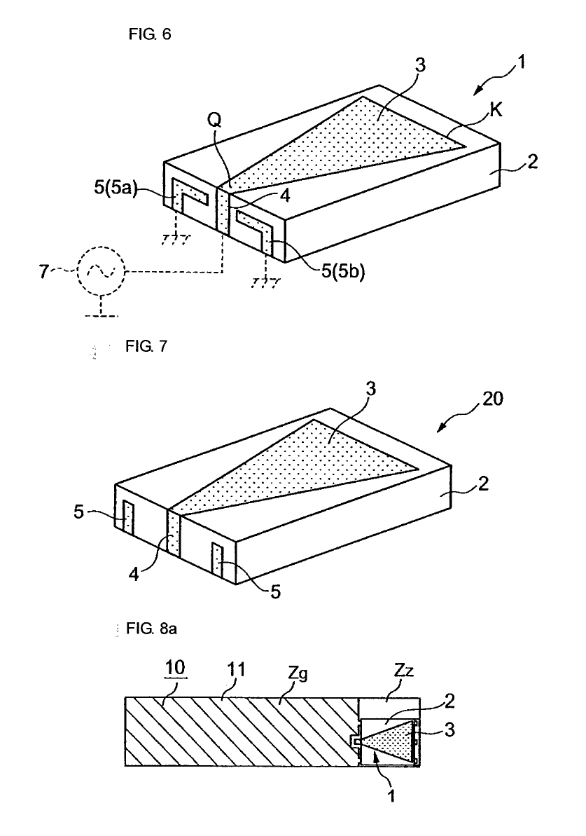

In the second embodiment, the surface-mount antenna 1 includes the radiation electrode 3, which has a triangular shape, as shown in the schematic perspective view of FIG. 6. One of the vertexes of the triangular radiation electrode 3 serves as the feeding portion Q and is connected to the feeding electrode 4. The bottom side, facing the feeding portion Q (vertex), of the radiation electrode 3 is the open end K. The configuration of the second embodiment is similar to that of the first embodiment, except for the shape of the radiation electrode 3 of the surface-mount antenna 1. The ground electrodes 5 (5a, 5b) are each disposed on either side of the feeding electrode 4 with a spacing therebetween. The spacing between the feeding electrode 4 and each of the ground electrodes 5 (5a, 5b) is smaller than the width of the feeding electrode 4.

The present inventor has checked by experiment that, as in the first embodiment, according to the surface-mount antenna 1 having the triangular radiation electrode 3 of the second embodiment, the advantages of increasing the frequency band and improving VSWR can be obtained by setting the spacing between the feeding electrode 4 and each ground electrode 5 to be smaller than the width of the feeding electrode 4.

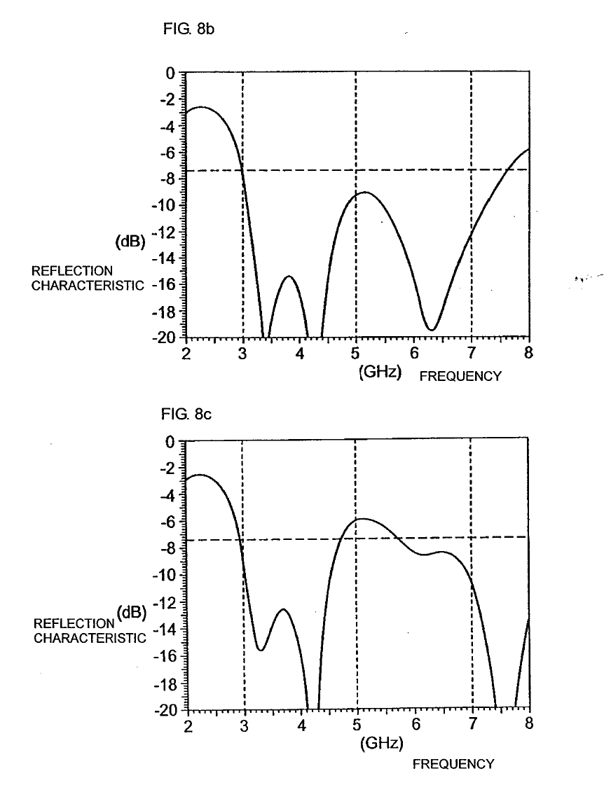

In that experiment, the reflection characteristic of sample A′ (i.e., the spacing between the feeding electrode 4 and each ground electrode 5 is smaller than the width of the feeding electrode 4), such as that shown in FIG. 6, and the reflection characteristic of sample B′ (i.e., the spacing between the feeding electrode 4 and each ground electrode 5 is larger than the width of the feeding electrode 4 (comparative example)), such as that shown in FIG. 7, were simulated under the condition that sample A′ and sample B′ were mounted on the non-ground area Zz of the circuit board 10, as shown in FIG. 8a. The experiment results are shown in FIGS. 8b and 8c. FIG. 8b illustrates the reflection characteristic of sample A′ (surface-mount antenna 1 of the second embodiment), while FIG. 8c illustrates the reflection characteristic of sample B′ (surface-mount antenna 20 of the comparative example). In this experiment, the dimensions of the circuit board 10 and the dimensions of the dielectric base members 2 of the surface-mount antennas 1 and 20 are the same as those of the counterparts in the experiment described in the first embodiment.

The experiment results show that, as in the first embodiment, in sample A′ (second embodiment), the resonant frequency of the higher modes gets closer to the resonant frequency of the fundamental mode compared with the case of sample B′ (comparative example). Accordingly, in sample A′, the frequency band of the higher modes is partially overlapped with that of the fundamental mode so that VSWR is improved and the frequency band is increased. More specifically, in sample B′, the frequency band implementing a reflection characteristic of −7.4 dB or lower (VSWR≦2.5) corresponds to two bands, i.e., the band from about 2.9 GHz to about 4.7 GHz and the band from about 5.7 GHz to 8 GHz or higher. On the other hand, in sample A′, the frequency band implementing a reflection characteristic of −7.4 dB or lower corresponds to one continuous band from about 3.0 GHz to about 7.6 GHz, thus achieving a wider bandwidth and an improved reflection characteristic (VSWR).

The present inventor further conducted the following experiment. In that experiment, the reflection characteristics of the surface-mount antenna 1 having the configuration of the second embodiment were simulated by variously changing the width H of the feeding electrode 4 and the spacing d1 and the spacing d2 between the feeding electrode 4 and the ground electrodes 5 in the following manner under the condition that the surface-mount antenna 1 was mounted on the circuit board 10, as shown in FIG. 8a. More specifically, in that experiment, in the surface-mount antenna 1, such as that shown in FIG. 6, the width H of the feeding electrode 4 was changed by 0.1 mm in a range from 0.3 mm to 2.0 mm including electrode widths that are usable in a practical sense. When the width H of the feeding electrode 4 ranges from 0.4 mm to 1.7 mm, the spacing d1 and the spacing d2 between the feeding electrode 4 and the ground electrodes 5 are set to be 0.3 mm, and are also changed to the value 0.9 times as long as the width H of the feeding electrode 4. The reason for fixing the smallest value of the spacing d1 and the spacing d2 between the feeding electrode 4 and the ground electrodes 5 to be 0.3 mm is that the smallest practical threshold of the spacing d1 and the spacing d2 is 0.3 mm from the viewpoint of the manufacturing process.

When the width H of the feeding electrode 4 ranges from 1.8 mm to 2.0 mm, the spacing d1 and the spacing d2 between the feeding electrode 4 and the ground electrodes 5 are set to be 0.3 mm. When the width H of the feeding electrode 4 is 0.3 mm, the spacing d1 and the spacing d2 between the feeding electrode 4 and the ground electrodes 5 are set to be the value (0.27 mm) 0.9 times as long as the width H of the feeding electrode 4. In this experiment, the dimensions of the circuit board 10 and the dimensions of the dielectric base member 2 of the surface-mount antenna 1 are the same as those of the counterparts in the experiment of the first embodiment. Also in this experiment, the width of the edge of the feeding portion Q of the radiation electrode 3 matches that of the feeding electrode 4 so that the edge of the feeding portion Q of the radiation electrode 3 can fit the feeding electrode 4.

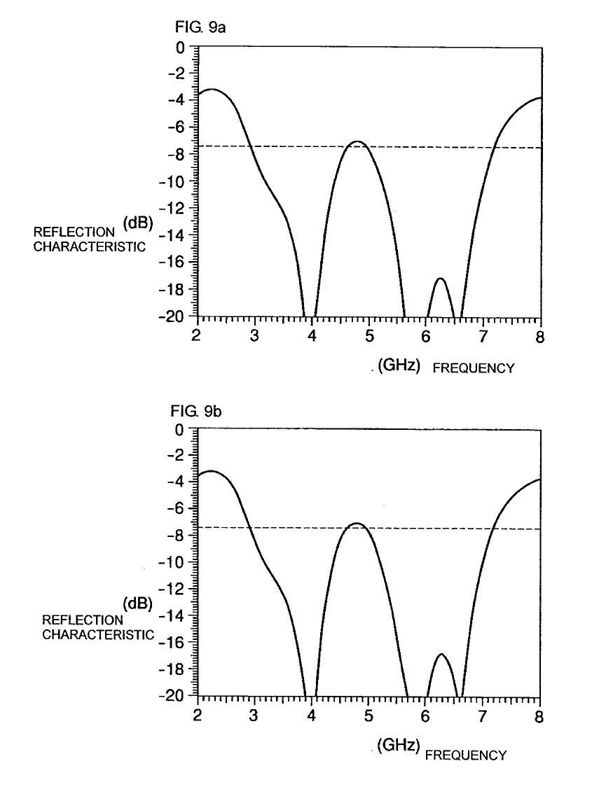

The simulation results are shown in FIGS. 9a through 24. More specifically, FIGS. 9a and 9b are graphs indicating the simulation results of the reflection characteristics of the surface-mount antenna 1 including the feeding electrode 4 having the width H of 0.4 mm: FIG. 9a illustrates the reflection characteristic of the surface-mount antenna 1 when the spacing d1 and spacing d2 between the feeding electrode 4 and the ground electrodes 5 are 0.3 mm; and FIG. 9b illustrates the reflection characteristic of the surface-mount antenna 1 when the spacing d1 and spacing d2 between the feeding electrode 4 and the ground electrodes 5 are equal to the value (0.36 mm) 0.9 times as long as the width H of the feeding electrode 4.

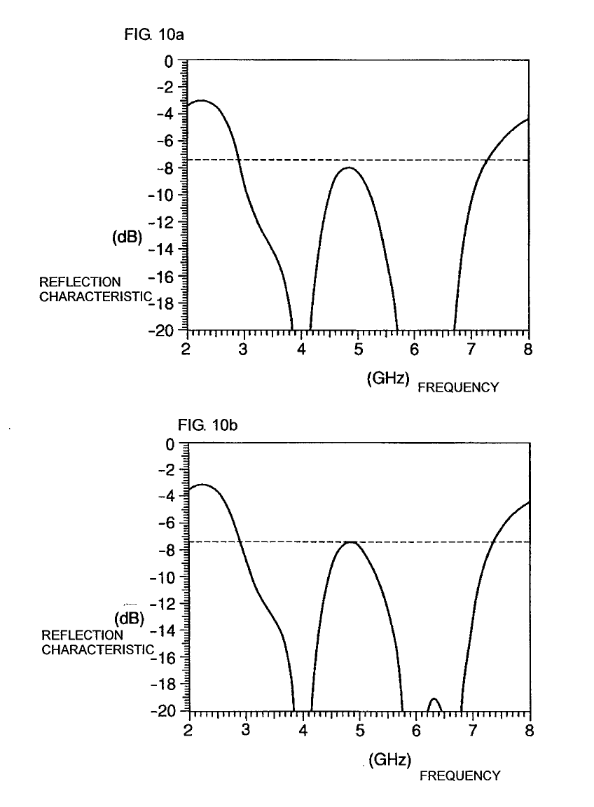

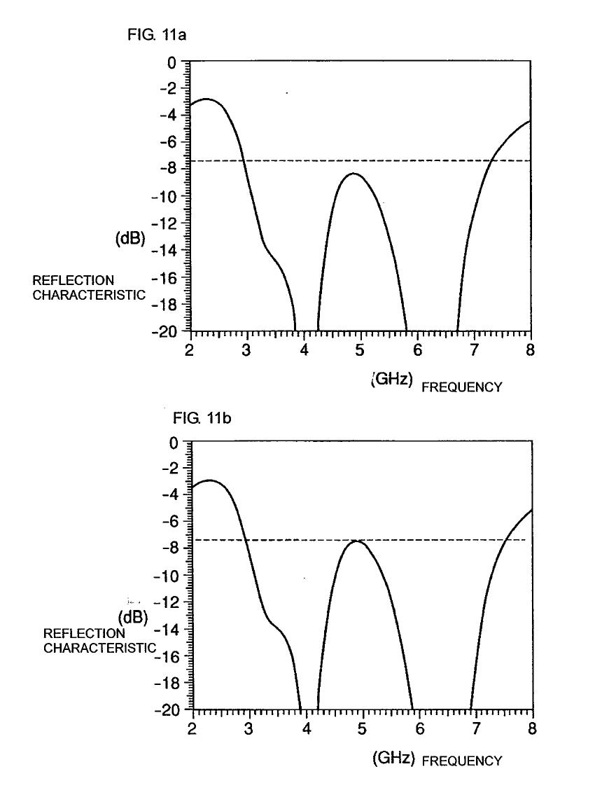

FIGS. 10a and 10b are graphs indicating the simulation results of the reflection characteristics of the surface-mount antenna 1 including the feeding electrode 4 having the width H of 0.5 mm: FIG. 10a illustrates the reflection characteristic of the surface-mount antenna 1 when the spacing d1 and spacing d2 between the feeding electrode 4 and the ground electrodes 5 are 0.3 mm; and FIG. 10b illustrates the reflection characteristic of the surface-mount antenna 1 when the spacing d1 and spacing d2 between the feeding electrode 4 and the ground electrodes 5 are equal to the value (0.45 mm) 0.9 times as long as the width H of the feeding electrode 4.

FIGS. 11a and 11b are graphs indicating the simulation results of the reflection characteristics of the surface-mount antenna 1 including the feeding electrode 4 having the width H of 0.6 mm: FIG. 11a illustrates the reflection characteristic of the surface-mount antenna 1 when the spacing d1 and spacing d2 between the feeding electrode 4 and the ground electrodes 5 are 0.3 mm; and FIG. 11b illustrates the reflection characteristic of the surface-mount antenna 1 when the spacing d1 and spacing d2 between the feeding electrode 4 and the ground electrodes 5 are equal to the value (0.54 mm) 0.9 times as long as the width H of the feeding electrode 4.

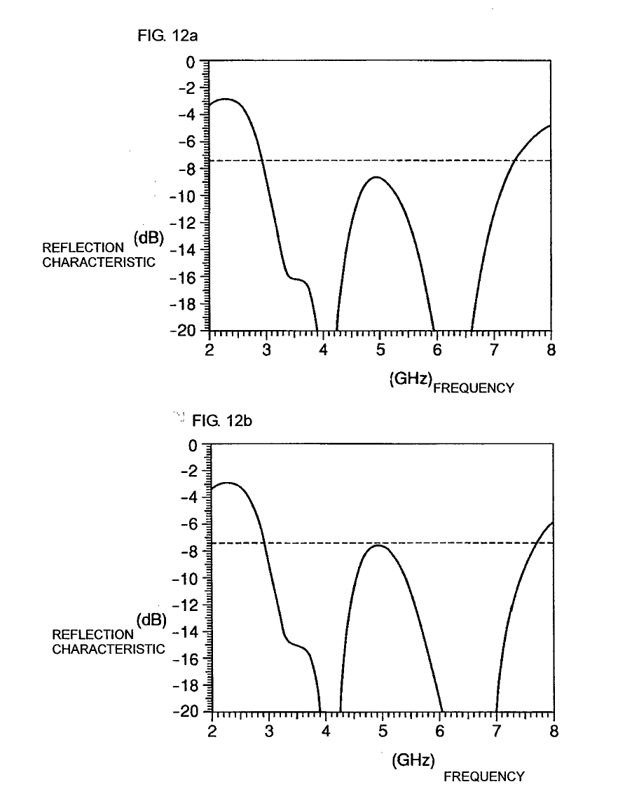

FIGS. 12a and 12b are graphs indicating the simulation results of the reflection characteristics of the surface-mount antenna 1 including the feeding electrode 4 having the width H of 0.7 mm: FIG. 12a illustrates the reflection characteristic of the surface-mount antenna 1 when the spacing d1 and spacing d2 between the feeding electrode 4 and the ground electrodes 5 are 0.3 mm; and FIG. 12b illustrates the reflection characteristic of the surface-mount antenna 1 when the spacing d1 and spacing d2 between the feeding electrode 4 and the ground electrodes 5 are equal to the value (0.63 mm) 0.9 times as long as the width H of the feeding electrode 4.

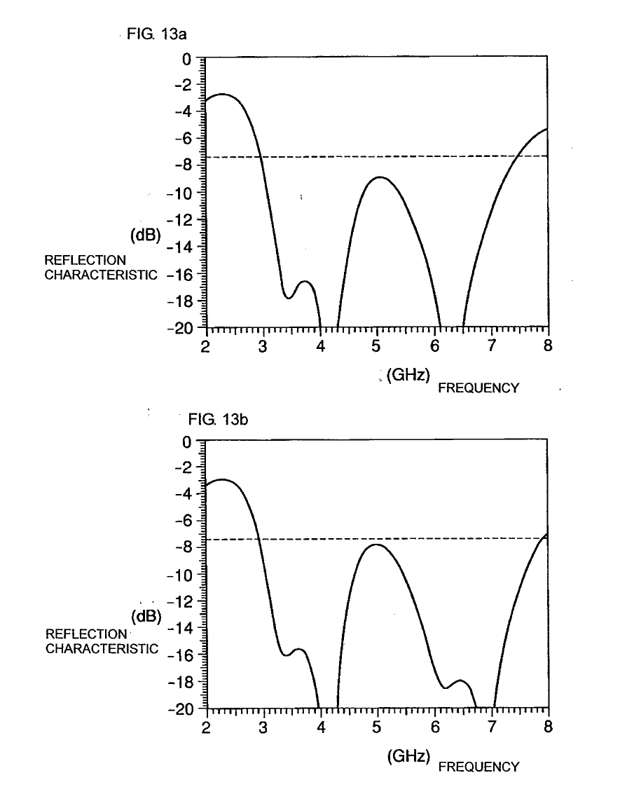

FIGS. 13a and 13b are graphs indicating the simulation results of the reflection characteristics of the surface-mount antenna 1 including the feeding electrode 4 having the width H of 0.8 mm: FIG. 13a illustrates the reflection characteristic of the surface-mount antenna 1 when the spacing d1 and spacing d2 between the feeding electrode 4 and the ground electrodes 5 are 0.3 mm; and FIG. 13b illustrates the reflection characteristic of the surface-mount antenna 1 when the spacing d1 and spacing d2 between the feeding electrode 4 and the ground electrodes 5 are equal to the value (0.72 mm) 0.9 times as long as the width H of the feeding electrode 4.

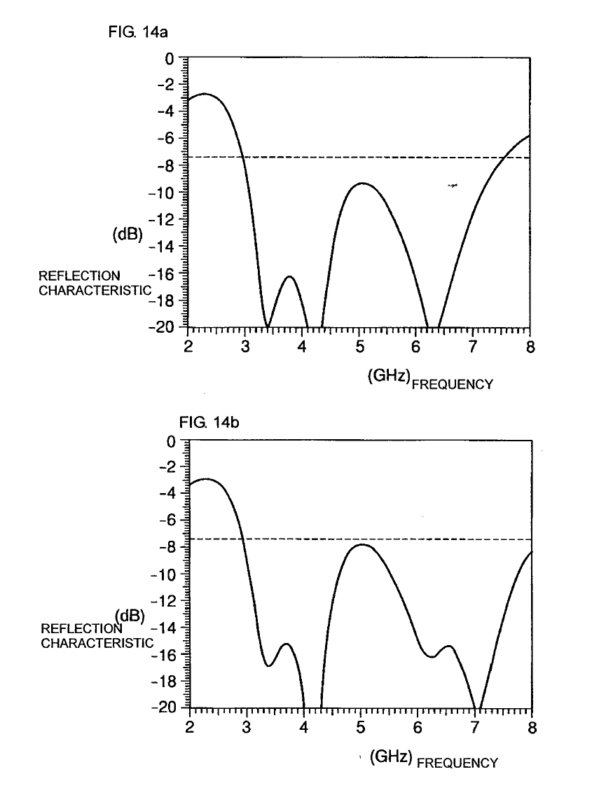

FIGS. 14a and 14b are graphs indicating the simulation results of the reflection characteristics of the surface-mount antenna 1 including the feeding electrode 4 having the width H of 0.9 mm: FIG. 14a illustrates the reflection characteristic of the surface-mount antenna 1 when the spacing d1 and spacing d2 between the feeding electrode 4 and the ground electrodes 5 are 0.3 mm; and FIG. 14b illustrates the reflection characteristic of the surface-mount antenna 1 when the spacing d1 and spacing d2 between the feeding electrode 4 and the ground electrodes 5 are equal to the value (0.81 mm) 0.9 times as long as the width H of the feeding electrode 4.

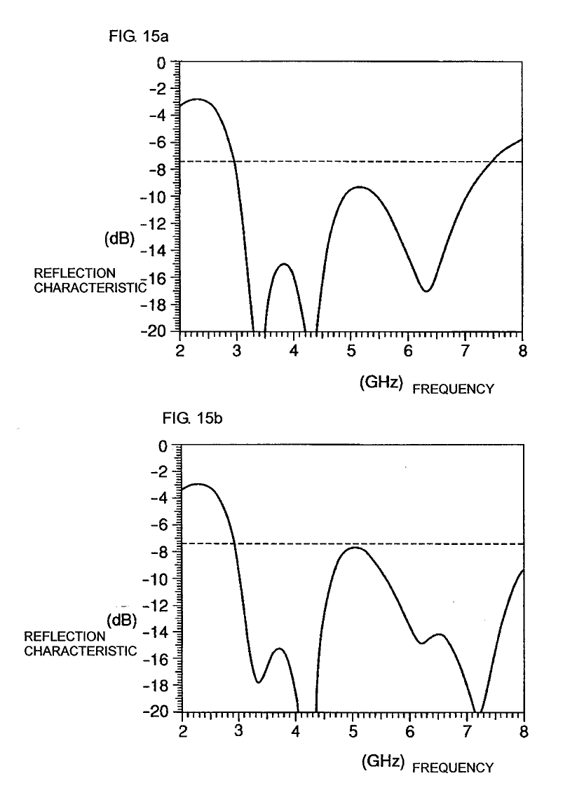

FIGS. 15a and 15b are graphs indicating the simulation results of the reflection characteristics of the surface-mount antenna 1 including the feeding electrode 4 having the width H of 1.0 mm: FIG. 15a illustrates the reflection characteristic of the surface-mount antenna 1 when the spacing d1 and spacing d2 between the feeding electrode 4 and the ground electrodes 5 are 0.3 mm; and FIG. 15b illustrates the reflection characteristic of the surface-mount antenna 1 when the spacing d1 and spacing d2 between the feeding electrode 4 and the ground electrodes 5 are equal to the value (0.90 mm) 0.9 times as long as the width H of the feeding electrode 4.

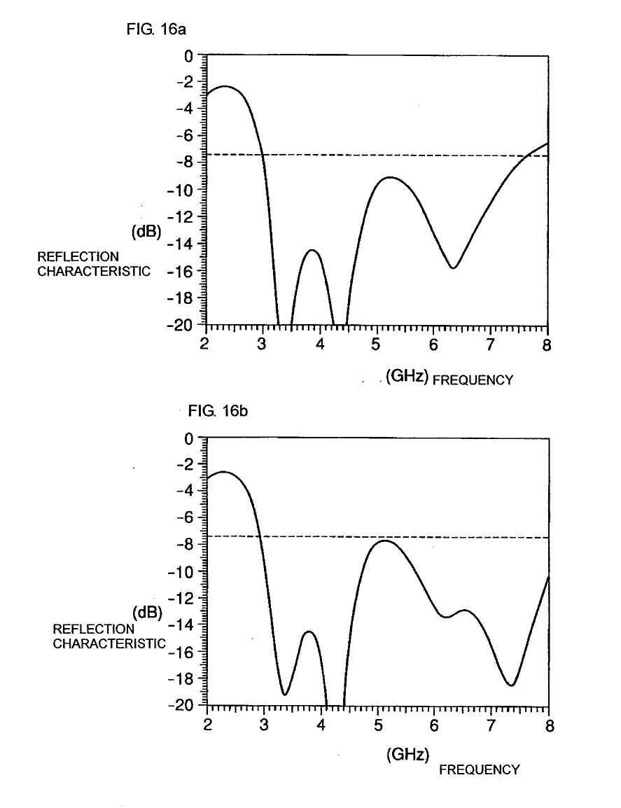

FIGS. 16a and 16b are graphs indicating the simulation results of the reflection characteristics of the surface-mount antenna 1 including the feeding electrode 4 having the width H of 1.1 mm: FIG. 16a illustrates the reflection characteristic of the surface-mount antenna 1 when the spacing d1 and spacing d2 between the feeding electrode 4 and the ground electrodes 5 are 0.3 mm; and FIG. 16b illustrates the reflection characteristic of the surface-mount antenna 1 when the spacing d1 and spacing d2 between the feeding electrode 4 and the ground electrodes 5 are equal to the value (0.99 mm) 0.9 times as long as the width H of the feeding electrode 4.

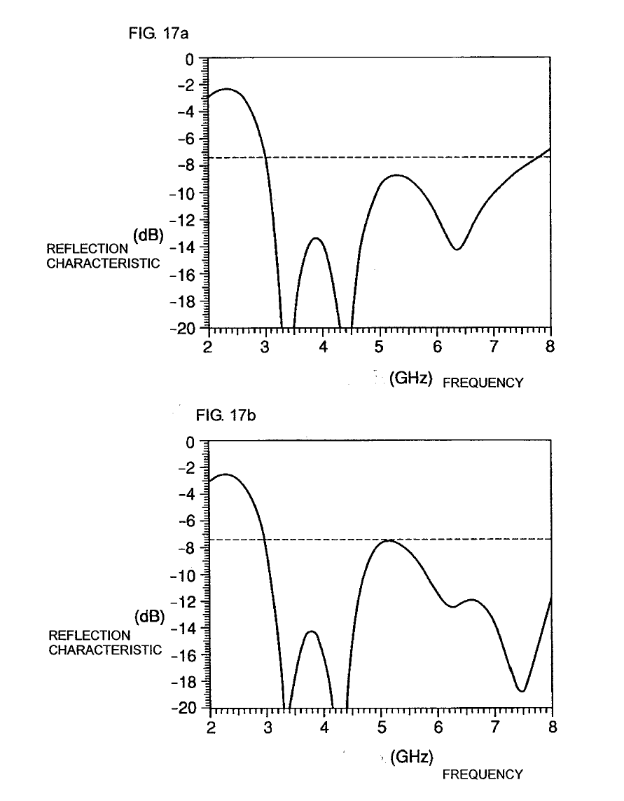

FIGS. 17a and 17b are graphs indicating the simulation results of the reflection characteristics of the surface-mount antenna 1 including the feeding electrode 4 having the width H of 1.2 mm: FIG. 17a illustrates the reflection characteristic of the surface-mount antenna 1 when the spacing d1 and spacing d2 between the feeding electrode 4 and the ground electrodes 5 are 0.3 mm; and FIG. 17b illustrates the reflection characteristic of the surface-mount antenna 1 when the spacing d1 and spacing d2 between the feeding electrode 4 and the ground electrodes 5 are equal to the value (1.08 mm) 0.9 times as long as the width H of the feeding electrode 4.

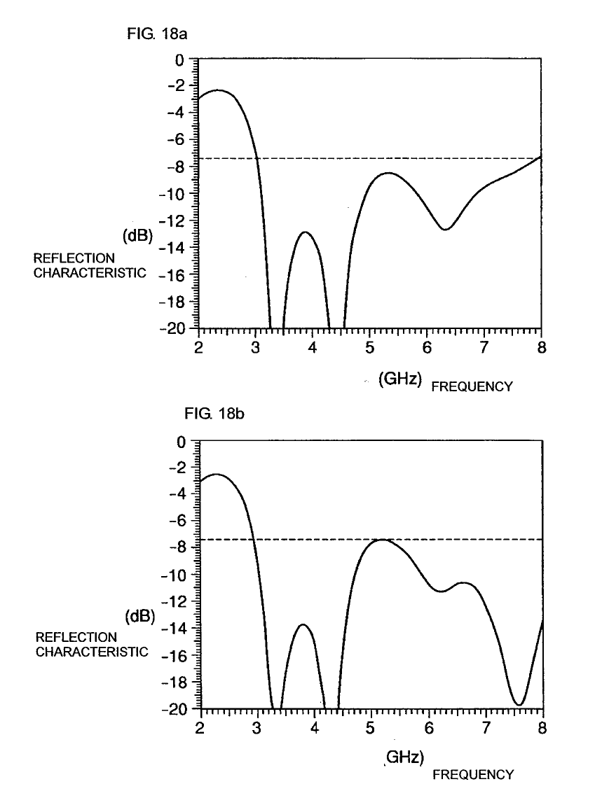

FIGS. 18a and 18b are graphs indicating the simulation results of the reflection characteristics of the surface-mount antenna 1 including the feeding electrode 4 having the width H of 1.3 mm: FIG. 18a illustrates the reflection characteristic of the surface-mount antenna 1 when the spacing d1 and spacing d2 between the feeding electrode 4 and the ground electrodes 5 are 0.3 mm; and FIG. 18b illustrates the reflection characteristic of the surface-mount antenna 1 when the spacing d1 and spacing d2 between the feeding electrode 4 and the ground electrodes 5 are equal to the value (1.17 mm) 0.9 times as long as the width H of the feeding electrode 4.

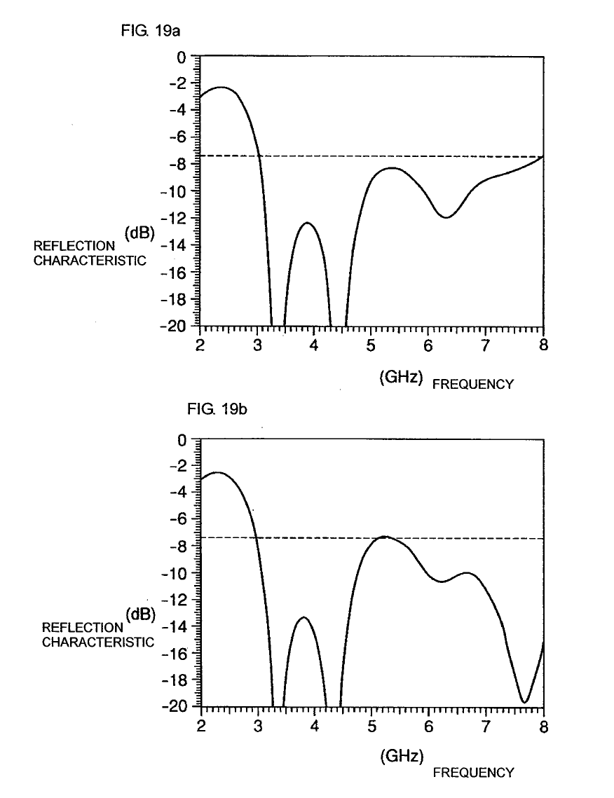

FIGS. 19a and 19b are graphs indicating the simulation results of the reflection characteristics of the surface-mount antenna 1 including the feeding electrode 4 having the width H of 1.4 mm: FIG. 19a illustrates the reflection characteristic of the surface-mount antenna 1 when the spacing d1 and spacing d2 between the feeding electrode 4 and the ground electrodes 5 are 0.3 mm; and FIG. 19b illustrates the reflection characteristic of the surface-mount antenna 1 when the spacing d1 and spacing d2 between the feeding electrode 4 and the ground electrodes 5 are equal to the value (1.26 mm) 0.9 times as long as the width H of the feeding electrode 4.

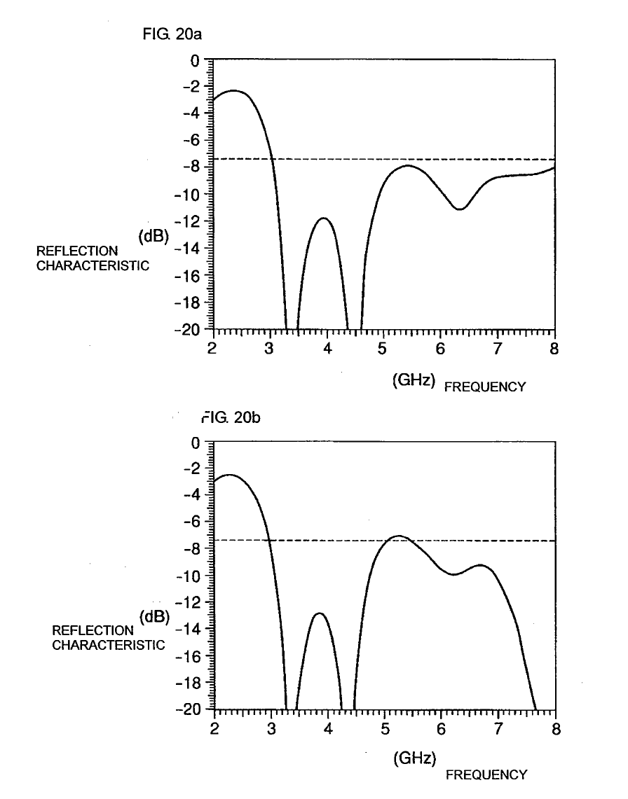

FIGS. 20a and 20b are graphs indicating the simulation results of the reflection characteristics of the surface-mount antenna 1 including the feeding electrode 4 having the width H of 1.5 mm: FIG. 20a illustrates the reflection characteristic of the surface-mount antenna 1 when the spacing d1 and spacing d2 between the feeding electrode 4 and the ground electrodes 5 are 0.3 mm; and FIG. 20b illustrates the reflection characteristic of the surface-mount antenna 1 when the spacing d1 and spacing d2 between the feeding electrode 4 and the ground electrodes 5 are equal to the value (1.35 mm) 0.9 times as long as the width H of the feeding electrode 4.

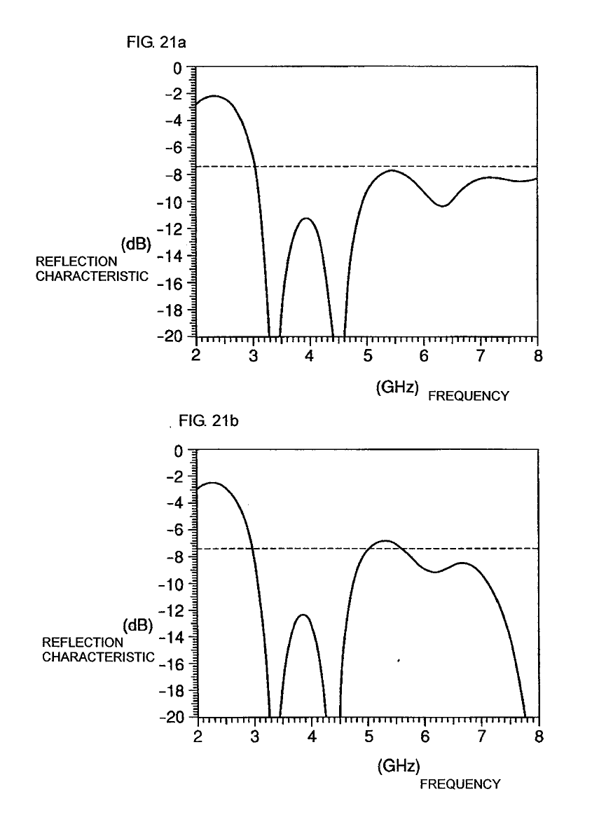

FIGS. 21a and 21b are graphs indicating the simulation results of the reflection characteristics of the surface-mount antenna 1 including the feeding electrode 4 having the width H of 1.6 mm: FIG. 21a illustrates the reflection characteristic of the surface-mount antenna 1 when the spacing d1 and spacing d2 between the feeding electrode 4 and the ground electrodes 5 are 0.3 mm; and FIG. 21b illustrates the reflection characteristic of the surface-mount antenna 1 when the spacing d1 and spacing d2 between the feeding electrode 4 and the ground electrodes 5 are equal to the value (1.44 mm) 0.9 times as long as the width H of the feeding electrode 4.

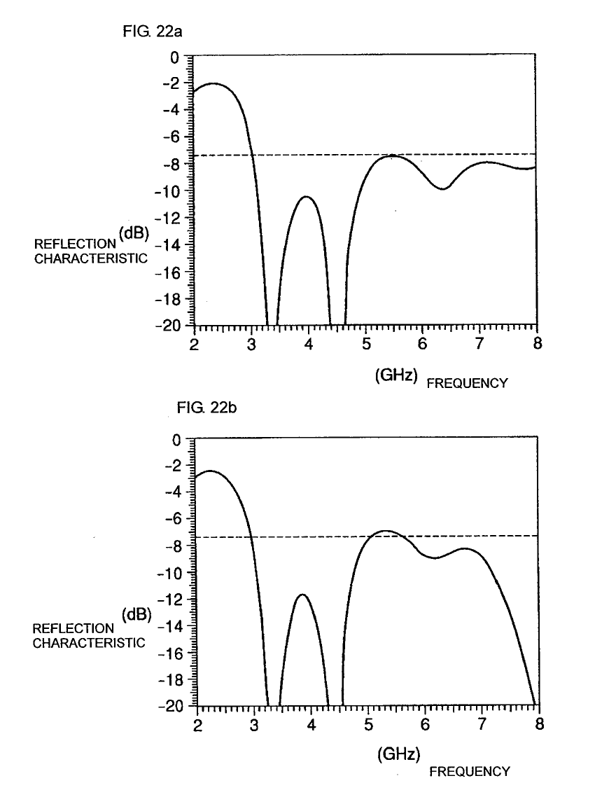

FIGS. 22a and 22b are graphs indicating the simulation results of the reflection characteristics of the surface-mount antenna 1 including the feeding electrode 4 having the width H of 1.7 mm: FIG. 22a illustrates the reflection characteristic of the surface-mount antenna 1 when the spacing d1 and spacing d2 between the feeding electrode 4 and the ground electrodes 5 are 0.3 mm; and FIG. 22b illustrates the reflection characteristic of the surface-mount antenna 1 when the spacing d1 and spacing d2 between the feeding electrode 4 and the ground electrodes 5 are equal to the value (1.53 mm) 0.9 times as long as the width H of the feeding electrode 4.

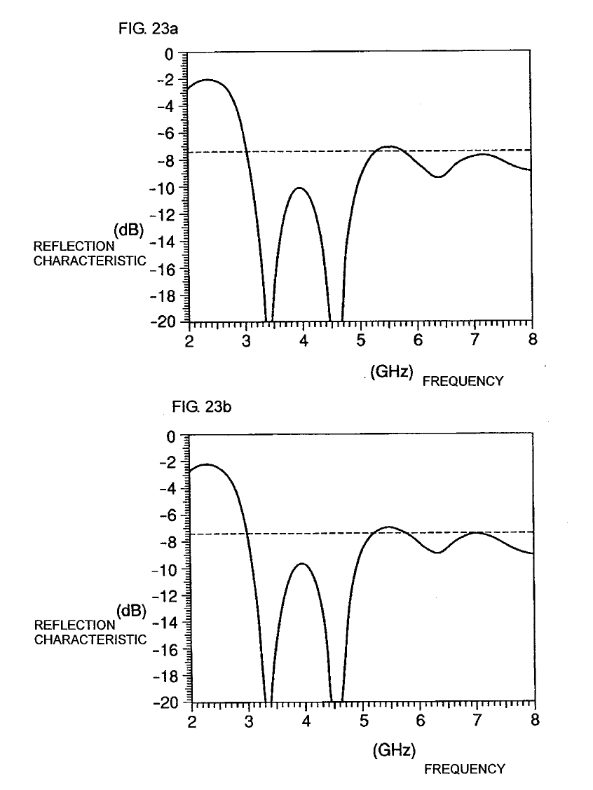

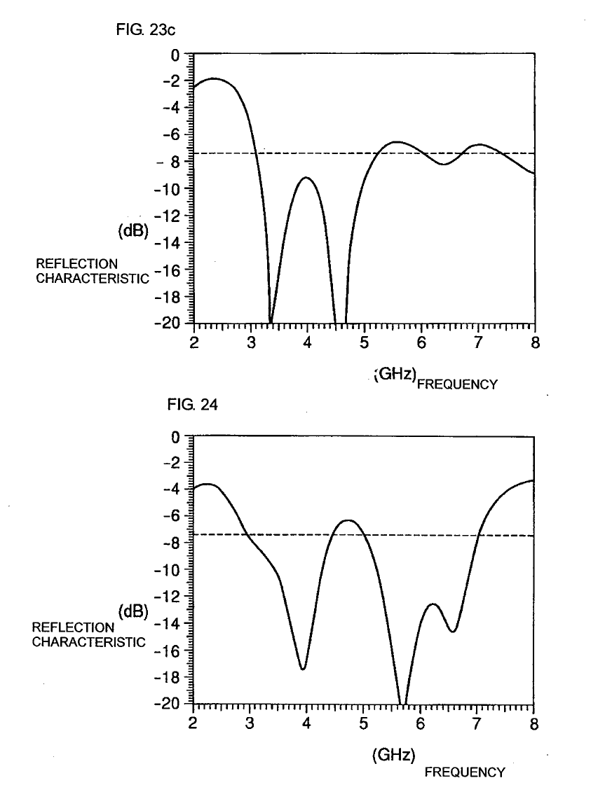

FIG. 23a is a graph indicating the simulation result of the reflection characteristic of the surface-mount antenna 1 including the feeding electrode 4 having the width H of 1.8 mm. FIG. 23b is a graph indicating the simulation result of the reflection characteristic of the surface-mount antenna 1 including the feeding electrode 4 having the width H of 1.9 mm. FIG. 23c is a graph indicating the simulation result of the reflection characteristic of the surface-mount antenna 1 including the feeding electrode 4 having the width H of 2.0 mm. All the reflection characteristics shown in FIGS. 23a through 23c are obtained under the condition that the spacing d1 and spacing d2 between the feeding electrode 4 and the ground electrodes 5 are 0.3 mm.

FIG. 24 is a graph indicating the simulation result of the reflection characteristic of the surface-mount antenna 1 including the feeding electrode 4 having the width H of 0.3 mm. The reflection characteristic shown in FIG. 24 is obtained under the condition that the spacing d1 and spacing d2 between the feeding electrode 4 and the ground electrodes 5 are equal to the value (0.27 mm) 0.9 times as long as the width H of the feeding electrode 4.

Upon comparing the simulation results shown in FIGS. 9a through 24 with the simulation result shown in FIG. 8c, the simulation results show that, if the spacing between the feeding electrode 4 and the ground electrode 5 is set to be smaller than the width of the feeding electrode 4 (see FIGS. 9a through 24), the resonant frequency of the higher modes gets closer to the resonant frequency of the fundamental mode than in the case where the spacing between the feeding electrode 4 and the ground electrode 5 is greater than the width of the feeding electrode 4 (see FIG. 8c), though there is no substantial difference in the resonant frequency of the fundamental mode.

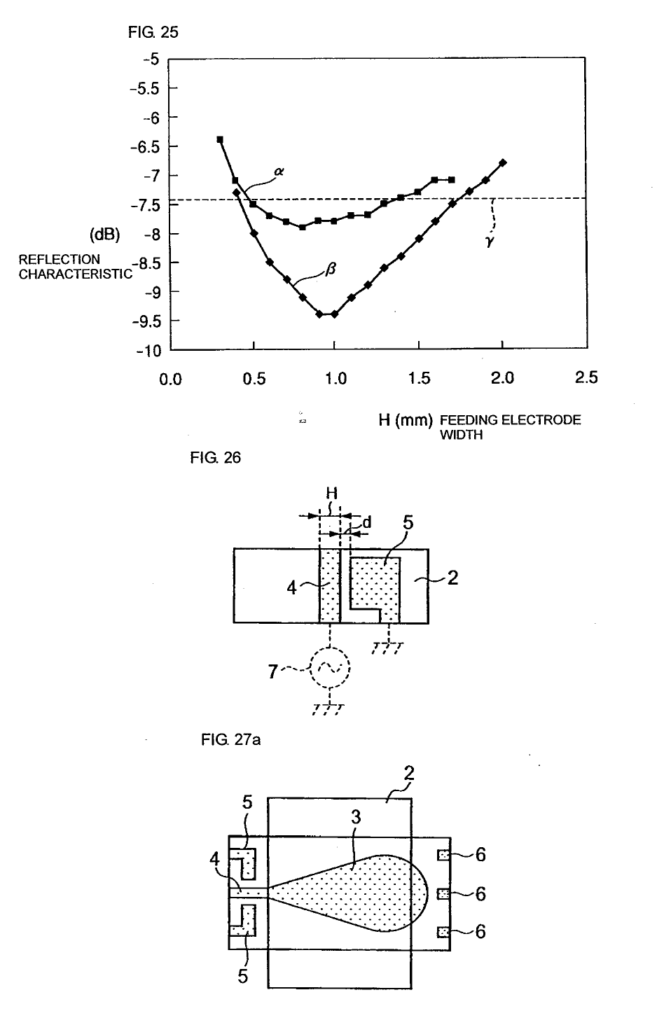

Based on the simulation results, the worst values of the reflection characteristics in the frequency range from the resonant frequency of the fundamental mode to the resonant frequency of the higher modes were checked. Then, the relationship between the width H of the feeding electrode 4 and the worst values of the reflection characteristics is indicated by the graph of FIG. 25. The solid line α shown in FIG. 25 is obtained under the condition that the spacing d1 and spacing d2 between the feeding electrode 4 and the ground electrodes 5 are equal to the value 0.9 times as long as the width H of the feeding electrode 4. The solid line β shown in FIG. 25 is obtained under the condition that the spacing d1 and spacing d2 between the feeding electrode 4 and the ground electrodes 5 are 0.3 mm.

The experiment results indicated by the graph of FIG. 25 show that, under the simulation condition, by setting the spacing d1 or d2 between the feeding electrode 4 and each ground electrode 5 to be smaller than the width H of the feeding electrode 4 when the width H of the feeding electrode 4 ranges from 0.5 mm to 1.7 mm, the resonant frequency of the higher modes gets closer to the resonant frequency of the fundamental mode to such a degree that the resonant frequency band of the higher modes is partially overlapped with that of the fundamental mode. As a result, a wide frequency band having a reflection characteristic of −7.4 dB or lower (VSWR≦2.5) (reflection characteristic below the broken line y in FIG. 25) can be obtained.

According to a third embodiment of the invention, a radio communication apparatus 7 is combined with the surface-mount antenna 1 of the first embodiment or the second embodiment, mounted on the circuit board 10, as shown in FIG. 3a. Any suitable radio communication apparatus can be used as the radio communication apparatus 7, so that an explanation thereof is omitted here. Since the first and second embodiments of the surface-mount antenna 1 have been described above, an additional explanation thereof is omitted as well.

The present invention is not restricted to the modes disclosed in the first through third embodiments, and various other modes may be employed. In the first through third embodiments, for example, the ground electrode 5 is disposed on either side of the feeding electrode 4. Alternatively, the ground electrode 5 may be disposed only on one side of the feeding electrode 4, as shown in FIG. 26, if the length of the ground electrode 5 facing the length of the feeding electrode 4 is sufficiently large so that the capacitance between the feeding electrode 4 and the ground electrode 5 (i.e., the capacitance between the feeding portion side of the radiation electrode 3 and the ground) is large enough to achieve a required wide frequency band. In this case, it is assumed that the spacing d between the feeding electrode 4 and each ground electrode 5 is smaller than the width H of the feeding electrode 4.

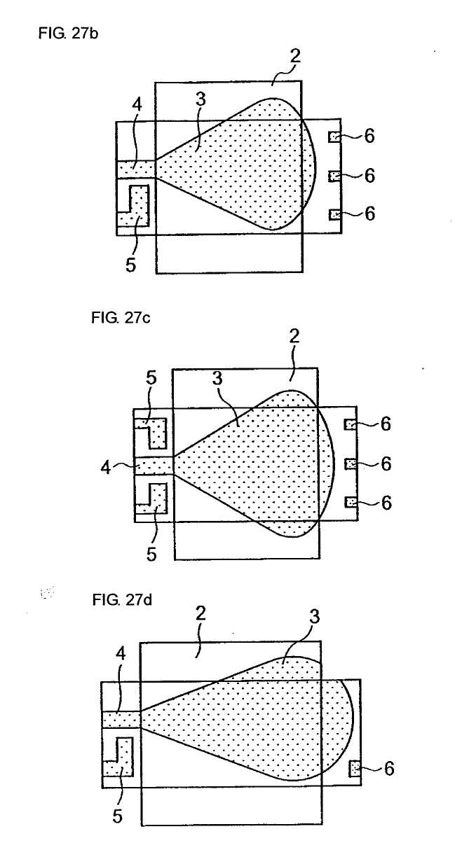

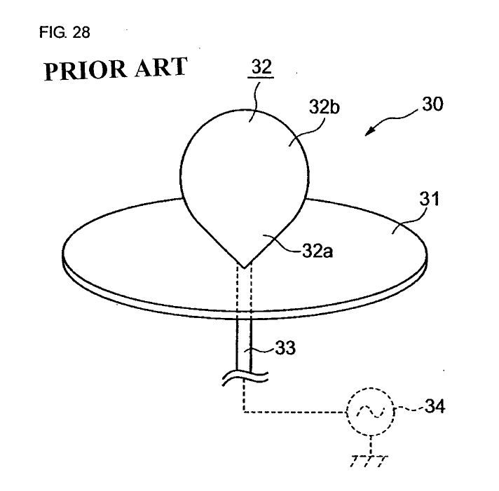

Additionally, according to the first through third embodiments, the radiation electrode 3 is formed only on the top surface of the dielectric base member 2. However, as shown in the exploded view of FIG. 27a, the radiation electrode 3 may be formed over two surfaces of the dielectric base member 2. Alternatively, the radiation electrode 3 may be formed, as shown in the exploded view of FIG. 27b, over three surfaces of the dielectric base member 2. In other embodiments, the radiation electrode 3 may be formed, as shown in the exploded view of FIG. 27c, over four surfaces of the dielectric base member 2. The radiation electrode 3 may be formed over five surfaces or six surfaces (all the surfaces) of the dielectric base member 2.

In this manner, the radiation electrode 3 may be formed over a plurality of surfaces of the dielectric base member 2. According to the configuration in which the radiation electrode 3 is formed over a plurality of surfaces of the dielectric base member 2, the area of the top surface (bottom surface) of the dielectric base member 2 can be decreased, and accordingly, the area occupied by the surface-mount antenna 1 on the circuit board 10 can also be decreased.

In the examples shown in FIGS. 27a, 27b, and 27c, the radiation electrode 3 is formed in a teardrop shape. However, the same applies to the radiation electrode 3 having a shape, for example, of a triangle, rather than a teardrop shape, and such a radiation electrode 3 may likewise be formed over a plurality of surfaces of the dielectric base member 2.

Further, the radiation electrode 3 may be partially notched, as shown in the exploded view of FIG. 27d. The radiation electrode 3 may also be provided with a projection. Further, it is not believed necessary for the radiation electrode 3 to be formed continuously. The invention is considered to include a radiation electrode with a hole or gap anywhere within its edge portions. However, it is preferable for the edge portions of the radiation electrode to define a continuous teardrop shape or triangular shape, as described above in connection with the first and second embodiments.

Although the radiation electrode 3 is formed in a teardrop shape in the first embodiment and in a triangular shape in the second embodiment, it may be formed in a shape other than a teardrop or a triangle as long as it has a portion where the width of the radiation electrode 3 is increased as it goes from the feeding portion Q toward the open end K.

Although in the first through third embodiments the base member forming the surface-mount antenna 1 is formed of a dielectric member, it may also be formed of a magnetic member.

According to the present invention, it is possible to reduce the sizes of the surface-mount antenna and the radio communication apparatus, while increasing the frequency band and improving VSWR. Thus, the surface-mount antenna and the radio communication apparatus are effective, particularly when being applied to a surface-mount antenna installed in a small radio communication apparatus and to a small radio communication apparatus.

Although the present invention has been described in relation to particular embodiments thereof, many other variations and modifications and other uses will become apparent to those skilled in the art. Therefore, the present invention is not limited by the specific disclosure herein.

1. A surface-mount antenna for being connected to a radio-communication high-frequency circuit to operate as an antenna, comprising:
a radiation electrode formed on a base member,
wherein one end of the radiation electrode serves as a feeding portion for being connected to the radio-communication high-frequency circuit, and the other end of the radiation electrode is an open end, the radiation electrode having a width which increases from the feeding portion toward the open end,
a band-like feeding electrode formed on the base member and connected to the feeding portion of the radiation electrode to serve to connect the feeding portion to the radio-communication high frequency circuit, and a ground electrode formed on the base member and disposed on at least one side of the feeding electrode so as to define a spacing with the feeding electrode, and
the spacing between the ground electrode and the feeding electrode is smaller than a width of the feeding electrode.

2. The surface-mount antenna according to claim 1, wherein the radiation electrode is formed in a triangle shape, and one vertex of the triangle shape serves as the feeding portion of the radiation electrode.

3. The surface-mount antenna according to claim 1, wherein the width of the feeding electrode is in a ranges from 0.5 mm to 1.7 mm.

4. The surface-mount antenna according to claim 2, wherein the width of the feeding electrode is in a ranges from 0.5 mm to 1.7 mm.

5. A radio communication apparatus comprising a circuit board which has a ground area provided with a ground electrode, and a non-ground area without a ground electrode,
wherein the surface-mount antenna set forth in any one of claims 1, 3 and 10 is disposed on the non-ground area of the circuit board, and
the circuit board includes connection means connecting the ground electrode of the surface-mount antenna to the ground electrode of the circuit board.

6-8. (canceled)

9. The radio communication apparatus according to claim 5, further comprising a radio-communication high-frequency circuit associated with said circuit board and being connected to the feeding electrode of the surface-mount antenna by a feeding wiring pattern on the circuit board.

10. The surface-mount antenna according to claim 1, wherein the radiation electrode is formed in a teardrop shape, and a tip of the teardrop shape serves as the feeding portion of the radiation electrode.

11. The surface-mount antenna according to claim 10, wherein the width of the feeding electrode is in a range from 0.5 mm to 1.7 mm.

12. The surface-mount antenna according to claim 1, wherein said base member is shaped as a rectangular parallelepiped having a top and a bottom major surface, and four lateral surfaces, said radiation electrode being formed on the top major surface and said feeding and ground electrodes being formed on a lateral surface thereof.

13. The surface-mount antenna according to claim 12, wherein said radiation electrode further extends from said top major surface onto at least one lateral surface other than the lateral surface on which said feeding and ground electrodes are formed.

14. The surface-mount antenna according to claim 1, wherein said ground electrode is formed on two opposite sides of the feeding electrode so as to define two corresponding spacings with the feeding electrode, and each of said two spacings is smaller than the width of the feeding electrode.
